(19) United States
(12) Patent Application Publication
(10) Pub. No.: US 2002/0031164 A1
(43) Pub. Date: Mar. 14, 2002

(54) Method and apparatus for photothermal analysis of a layer of material, especially for thickness measurement thereof

(76) Inventors: Michael Scheidt, Au (CH); Hansruedi Moser, Hinterforst (CH); Horst Adams, Altstatten (CH)

Correspondence Address: FENWICK & WEST LLP, TWO PALO ALTO SQUARE, PALO ALTO, CA, 94306, US

(21) Appl. No.: 09/808,673

(22) Filed: Mar. 14, 2001

(30) Foreign Application Priority Data
Mar. 17, 2000 (DE) 10013172.7

(51) Int. Cl. G01N 25/72; G01N 25/00

(52) U.S. Cl. 374/7; 374/5

(57) ABSTRACT

Method and apparatus for photothermal analysis of a layer of material, especially for thickness measurement thereof. The invention relates to a method of photothermal analysis of a layer of material, especially of measuring the thickness of a layer, wherein the surface of a first layer of material is excited by electromagnetic radiation and heat radiation emitted by said surface and having a first temperature response curve is detected, the surface of a second layer of material is excited and heat radiation emitted by said surface and having a second temperature response curve is detected, the first layer of material being a reference layer and the second layer of material being the layer of material to be analyzed. A stretch factor is determined between the first and second temperature response curves, and the stretch factor is used as a characteristic factor for the ratio between the layer of material to be analyzed and the reference layer. The invention likewise provides a corresponding apparatus for photothermal analysis and a computer program to carry out the method.

### BACKGROUND OF THE INVENTION

The invention relates to a method of and an apparatus for photothermal analysis of a layer of material, especially for measuring the thickness of a layer of material, as defined in the preambles of claims 1 and 14, respectively.

It is known to use photothermal measuring methods for non-contact analysis of layers of material, in particular for measuring the thickness of layers.

A conventional solution known in the art provides for use of a modulated, continuously emitting light source to excite a thermal wave in the object to be measured. The underlying principle, also known as photothermal radiometry, is based on the radiation of temperature waves in a test object, the waves propagating in a way which is characteristic of the nature of the material of which the test object is made. In a manner similar to ultra-sonic waves, the waves are scattered or reflected as they impinge on thermal inhomogeneties, such as layer boundaries, delaminations, fissures, pores, etc. Essential differences as compared to ultrasonic applications reside in stronger attenuation and a much slower speed of propagation. The reflected or scattered portions of the temperature wave interfere with the original or excitation wave, forming a sum vector of the temperature wave, partly so after multiple reflections or scatterings. The measured information contained in the sum vector about the workpiece under investigation is a vector amount (or an amplitude) as well as a phase. The vector amount, for being greatly dependent on external factors like measuring point distance and irradiation angle which are not adjustable with sufficient precision in industrial application, is not very helpful. The phase, on the other hand, is largely independent not only of those factors but also of the power of the intensity-modulated excitation radiation and, therefore, very reliable to be used upon for evaluation. The nature of a workpiece surface, for instance its thickness, can be determined on the basis of the phase shift of the infrared thermal radiation emitted by the workpiece with respect to the irradiated excitation radiation (cf. for example DE 195 48 036 C2).

Before using it for measurements, the measuring system must be calibrated to permit judgments of the material layer, especially to derive the absolute thickness of the layer from the photothermal measurement.

With the procedure described above of the analysis of thermal radiation this means that an absolute thickness of the layer can be associated with a phase shift measured. A known calibration procedure will be described below with reference to the example of coating sheet material with a coating powder and measuring the thickness of the coating powder layer.

(1) At least two sample sheets are coated with coating powder which later on will be used in the coating of workpieces. Care must be taken to obtain coating layers on the two samples which differ sufficiently in thickness, in other words, one sheet should receive a thin coating layer and the other one a thick coating layer. The two coating layer thicknesses selected will establish the measuring range of the system.

(2) Subsequently the two sample sheets are subjected to photothermal measuring. The signals obtained, in other words the heat radiated is evaluated so as to determine a respective characteristic value for each sheet. In the example described above, the characteristic value results from the corresponding phase shift.

(3) The coating powder on both sample sheets is annealed.

(4) The absolute thicknesses of the layers on the two sample sheets are measured by a different measuring method, e.g. by eddy current measurement.

(5) The respective characteristic values (phase shifts) are associated with the absolute layer thickness values thus obtained. The value pairs are stored in an evaluating unit so that at least two backup values for a calibration curve (phase versus layer thickness) will be available with the calibration procedure described.

The characteristic values measured (phase shifts) of the coated workpieces then may be associated with a layer thickness, based on the calibration curve. To do that, interpolation between the backup values and, if desired, also extrapolation are applied; in the simplest case linear interpolation will be chosen.

This alone reveals a disadvantage of the known method of calibrating. When the sample sheets are coated, it is necessary to pay attention that the thicknesses of the resulting layers are sufficiently different because the two backup values of the calibration curve will define the measuring range. On the other hand, the two backup values must not be too far apart from each other because otherwise the interpolation (or extrapolation) error becomes too big.

A fundamental problem in producing the sample sheets is due to the fact that no coating layer can be applied which will have a thickness corresponding to that of the workpieces to be produced later because the coating shrinks during annealing. For this reason too much or too little of a coating layer must be applied on the sheets.

If sufficient measuring accuracy is to be warranted no more than a narrow measuring range may be defined by two backup values. If it is desired to cover a wider measuring range this can be achieved only by increasing the number of backup values and, therefore, the number of sample sheets. The time required for calibrating the measuring system will increase correspondingly.

Another method of photothermal determination of the thickness of a surface coating layer is described in DE 195 20 788 A1. In that case a surface coating layer and a substrate without a coating layer are excited by light pulses. The pulse duration is selected such that the maximum difference is obtained between the temperature response curves of the surface coating layer and the uncoated substrate. The characteristic value used for assessing the surface quality is the time at which the maximum temperature To has dropped to a temperature of T=T₀·e⁻¹. That, however, entails practically the same disadvantages as described above, and each individual measurement is rather time consuming. Besides, the determination of the point in time is critical for reasons of noise and involves great uncertainties in the measuring technique.

DE 195 20 788 A1 describes yet another calibration method with which the temperature curves measured of the surfaces to be examined are compared with memorized temperature curves determined empirically for known thicknesses of layers. Where an empirical temperature curve corresponds to the measured temperature curve the relevant layer thickness can be associated. The publication provides no solution in the event the curves do not match.

Extensive computing expenditure is required for the method described in DE 195 20 788 A1 of comparing the temperature curves; a separate set of comparative curves must be generated and stored in the evaluating unit for each type of powder. Thus the method described, on the whole, is burdened by expenditure for the setup and calibration of the measuring system.

It is also suggested in DE 195 20 788 A1 to compare the temperature curves with theoretical temperature curves. The theoretical temperature curves are explained by the model of a so-called thermal capacitor which is explained in detail in the publication. It is not stated in DE 195 20 788 A1 how the curves are to be compared.

In connection with the method described, the comparison is made between temperature curves during the cooling phase of a workpiece coating operation. That leads to a further extension of the measuring time.

The measures described in the art for calibrating a photothermal measuring system are so-called reference methods. What this means is that a temperature curve or a characteristic value of a layer of material to be analyzed is determined, and an identical characteristic value or an identical temperature curve of a reference layer is searched for or determined by interpolation between two characteristic values of reference layers. Associating the characteristic values of the reference layers with the corresponding absolute layer thicknesses can provide the absolute thickness of the layer to be analyzed, either directly or by interpolation, based on the calculated characteristic value of that layer.

Thus it is obvious that the quality of the photothermal measurement of the thickness of layers is highly dependent on calibration and that means, in particular, that the reference layers must be prepared with great care. That involves an enormous amount of time and, moreover, production is severely interfered with by the calibration.

It is, therefore, the object of the present invention to provide a method of and an apparatus for photothermal analysis of a layer of material, especially for measuring the thickness of a layer, by means of which the disadvantages described of the prior art are overcome and, in particular, a simpler method of calibrating the photothermal measuring system is provided. The novel calibration method in particular is intended to cause the least disturbance possible of the course of production when workpieces are coated.

### SUMMARY OF THE INVENTION

The object is met, in accordance with one aspect of the invention, by a method of photothermal analysis of a layer of material, especially of measuring the thickness of a layer, wherein the surface of a first layer of material is excited by electromagnetic radiation and heat radiation emitted by said surface and having a first temperature response curve is detected, and the surface of a second layer of material is excited and heat radiation emitted by said surface and having a second temperature response curve is detected, wherein a stretch factor is determined between the first and second temperature response curves, and the stretch factor is used as a characteristic value for a ratio between said first and second layers of material.

According to a further aspect the present invention provides an apparatus for photothermal analysis of a layer of material, especially for measuring the thickness of a layer, comprising a excitation source for exciting the surfaces of at least first and second layers of material; a detector for detecting the heat radiation emitted by the surfaces of the layers and having first and second temperature response curves, respectively; and an evaluation unit, wherein the evaluation unit determines a stretch factor between the first temperature response curve and the second temperature response curve, the stretch factor being useful as a characteristic value of a ratio between the first and second layers of material.

The invention provides a method of photothermal analysis of a layer of material, especially of measuring the thickness of a layer, wherein the surface of a first layer of material and the surface of a second layer of material are excited by electromagnetic radiation and heat radiation emitted by the surfaces of the layers is detected with first and second temperature response curves, respectively. A stretch factor is determined between the first and second temperature response curves, and the stretch factor is used as a characteristic value for a ratio between the first and second layers of material. More specifically, in the method according to the invention the first layer of material is a reference layer and the second layer of material is the layer of material to be analyzed.

The method according to the invention permits calibration of the measuring system, at least for a certain measuring range, on the basis of a single reference measurement made on a reference layer. As will be explained below, the thickness of the layer of material can be found in relation to the thickness of the reference layer using the stretch factor between the two associated temperature curves. Moreover, the calibrating measurement can be made on a workpiece carrying a coating layer of a desired thickness so that excess or deficiency coating of sample sheets can be dispensed with. It is not necessary either to determine the absolute thickness of the layer after annealing if the thickness of the layer is intended to be measured only with respect to a reference layer. Hereby a method of photothermal analysis of a layer of material is obtained which has only minor disturbing influence on the process of the production of coated workpieces and which is very advantageous as regards the number of measurements which must be made.

The stretch factor between the two temperature curves preferably is determined with reference to time. It is likewise feasible to realize a stretch factor in the direction of the amplitude. However, as the amplitude of the temperature curve depends on the power and irradiation angle of the excitation radiation, the measuring point distance and similar factors, it is preferred to utilize the time-related stretch factor which is independent of those factors and more stable.

In dependence on the time-related stretch factor, the ratio of the thicknesses of the two layers of material can be derived in simple manner, using the following equation

$$\frac{L1}{L2} \approx \sqrt{{γ}_{2}}$$

wherein L1=thickness of the first layer of material, L2=thickness of the second layer of material, and Υ₂ the time-related stretch factor between the temperature curves of the two layers of material.

The stretch factor may be determined in different ways. For instance, the second temperature curve of the layer of material to be analyzed may be mapped into the first temperature curve of the reference layer to determine the stretch factor. Alternatively or in addition, a characteristic value may be determined for each temperature curve, and then the stretch factor is determined in response to that characteristic value. In this case the time-related stretch factor is determined, for example, on the basis of the time intervals at which the characteristic values are identical. To this end it may be advantageous, although not a must, to store the first temperature curve of the reference layer.

Once the absolute thickness of the reference layer is known, the absolute thickness of the layer of material to be analyzed can be determined on that basis. In many cases of practical application it may be sufficient to find out whether or not the layer to be analyzed differs from the reference layer which, for instance, may have a desired thickness and, if it does, what the percentage deviation is.

To provide a temperature curve which can be evaluated straightaway, the surfaces of the layers of material should be excited with a step function of the electromagnetic radiation. But it is possible also to use a modulated excitation source which, for example, emits several excitation pulses.

The invention thus provides a method by means of which a layer of material can be characterized and, in particular its thickness can be determined at minimum calibration expenditure for the measuring system and with but one reference layer, simply by comparing two temperature curves. Furthermore, the power of the excitation source and the characteristic of the detector or the spacing between excitation source, workpiece, and detector need not be known when using the time-related stretch factor, as is particularly preferred with the invention. And in addition they need be constant only during the very short measuring interval, provided the temperature curves are standardized appropriately.

### SHORT DESCRIPTION OF THE DRAWINGS

The invention will be described in greater detail below, by way of preferred embodiments, with reference to the accompanying drawings, in which:

FIG. 1 shows an apparatus for photothermal analysis of a layer of material according to the invention;

FIG. 2 shows a cutout of a workpiece with a layer of material whose thickness is to be determined;

FIG. 3 shows a time diagram of the temperature of thermal radiation emitted by two different layers of material;

FIG. 4 shows a similar time diagram of the temperature as shown in FIG. 3, with stretch factors included to illustrate the method according to the invention.

### DETAILED DESCRIPTION OF PREFERRED EMBODIMENTS

The invention now will be described with reference to an example of measuring the thickness of a layer. However, it is applicable just as well for analyzing other properties of the layer of material, such as its composition.

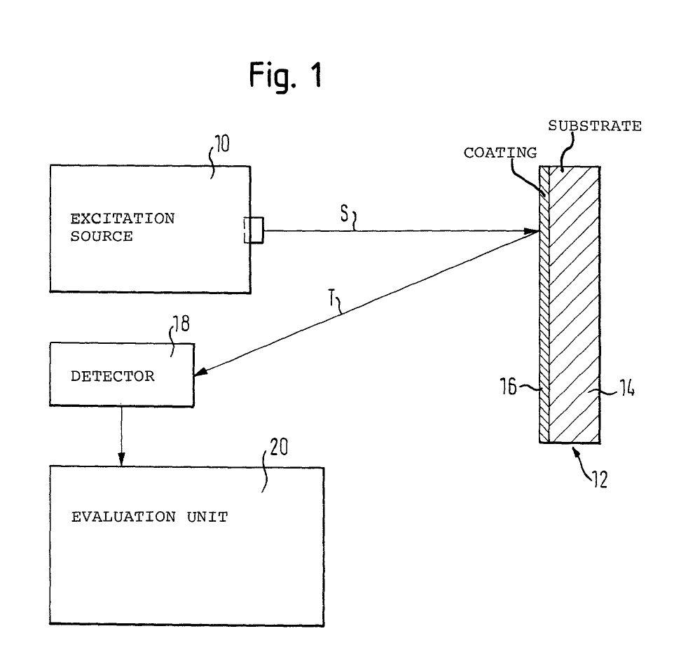

FIG. 1 is a schematic representation showing an apparatus for photothermal analysis of a layer of material according to the invention in the form of a block diagram. The apparatus comprises an excitation source 10 for generating electromagnetic excitation radiation S. The excitation source 10 preferably is a laser source, but infrared light or electromagnetic excitation radiation having another wavelength range likewise may be used. The excitation beam S impinges on a workpiece 12 comprising a substrate 14 and a coating layer 16. The surface of the workpiece 12 is heated by the excitation radiation S and emits heat radiation T which is detected by a detector 18. The detector 18 converts the heat radiation T detected into electrical signals and passes them on to an evaluation unit 20.

The evaluation unit 20 shown in FIG. 1 calculates the stretch factor, and based on the stretch factor the desired thickness of the layer is determined, as will be explained in greater detail below.

With the method according to the invention the excitation source 10 radiates light of an appropriate wavelength on to the layer 16 to be examined. It is possible to use a quasi continuous light source for this purpose, and the irradiation, at most, should last just so long that the layer 16 will not suffer any negative influence and that laser safety rules are observed, in the even that a laser source is used. The excitation radiation preferably is applied in the form of a step function, and the excitation source 10 is shut off or the excitation radiation S interrupted before the next measurement, at the latest. In the event that a layer 16 should have to be measured several times at the same place of the workpiece 12 a time span for cooling down of the measuring point between measurements should be taken into account.

Furthermore, the measuring time at least should equal or be longer than the thermal diffusion time τ

$$τ = \frac{{l}_{s}^{2}}{α}$$

$$α = \frac{k}{ρ \cdot c}$$

wherein:

α=thermal diffusiveness (m2/s)

k=heat conductivity (W/(mK9))

ρ=mass density (kg/m3)

c=specific heat capacity (J/(kgK)

lₛ=layer thickness (m)

The duration of excitation thus is an uncritical factor for the evaluation method according to the invention.

The thermal radiation generated by the excitation is detected by a suitable detector 18, i.e. the variation in time of the temperature is measured. In general, with quasi continuous excitation, it is possible to measure from the beginning to the end of the excitation.

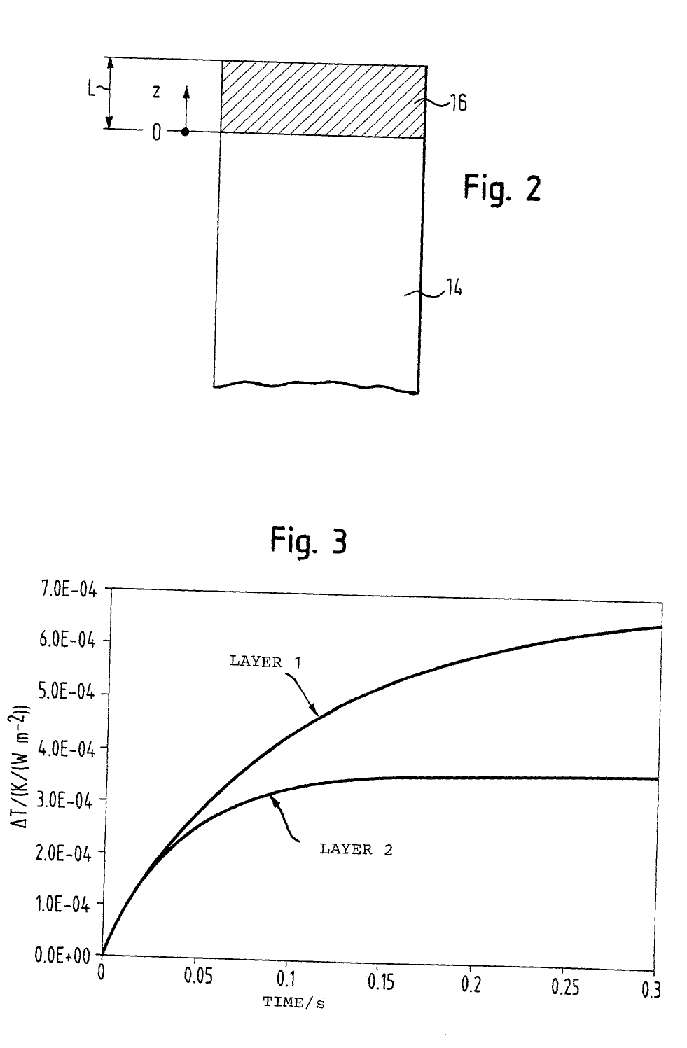

FIG. 2 shows typical time-related temperature response curves for two different layer thicknesses.

The description below refers to the preferred embodiment of the invention with which the rise in temperature of the heat radiation emitted, upon stepwise switch-on of the electromagnetic excitation radiation, is evaluated so that the calibration takes place during the warm-up phase on the basis of the temperature rise. In principle, however, the invention is applicable to the cooling phase as well, provided the drop in temperature upon switch-off of the electromagnetic radiation is evaluated.

The basis of the method according to the invention lies in the thermal diffusion equation (1) which provides a mathematical specification of the system under investigation of electromagnetic excitation and heat radiation emitted:

$${∇}^{2} T ( x , y , z , t ) - \frac{1}{α} \cdot \frac{\partial T ( x , y , z , t )}{\partial t} = - \frac{H ( x , y , z , t )}{k} \qquad ( 1 )$$

wherein

T (x, y, z, t)=temperature rise over reference temperature T0

H (x, y, z, t)=heat put in per volume and time

α=thermal diffusivity (m2/s):

$$α = \frac{k}{ρ \cdot c}$$

k=heat conductivity (W/(mK))

ρ=mass density (kg/m3)

c=specific heat capacity (J/(kgK))

H(x, y, z, t) results from the irradiating radiation power I0 of the excitation source 10 and its absorption in the layer 16. The exponential drop in the layer 16 is described by the absorption coefficient á. By way of simplification it may be assumed, moreover, that the one-dimensional diffusion equation is valid for thin layers and a customary excitation area. The resulting equation for the system thus is:

$$\frac{{\partial }^{2} T}{\partial {z}^{2}} ( z , t ) - \frac{1}{α} \cdot \frac{\partial T}{\partial t} ( z , t ) = - \frac{β {I}_{0} exp ( - β \cdot z )}{k} \qquad ( 2 )$$

This equation (2) describes the course in time and space of the temperature response upon excitation by a radiation power I0.

It follows from this differential equation (2) that the temperature curve is determined by three magnitudes α, β, and I0. It is assumed for the proposed method that α and β are constant within the layers.

The temperature curve for a layered system as illustrated in FIG. 2, consisting of a substrate 14 and a layer 16 may be calculated by using equation (2) and the known magnitudes α, β, and I0. The calculation below was made for a layer 1 having a thickness of 180 μm and a layer 2 having a thickness of 110 μm. The substrate was assumed to be steel of infinite thickness, i.e. the thickness of substrate 14 is much greater than that of layer 16. Moreover, the following values were assumed:

α=1,19·10⁻⁷ M²/s

k=0,20 W/(mK)

β=2000 m⁻¹

I₀=1 W/m²

FIG. 3 shows the temperature curves or rises in temperature calculated for layer 1 which was 180 μm thick and layer 2 of which the thickness was 110 μm.

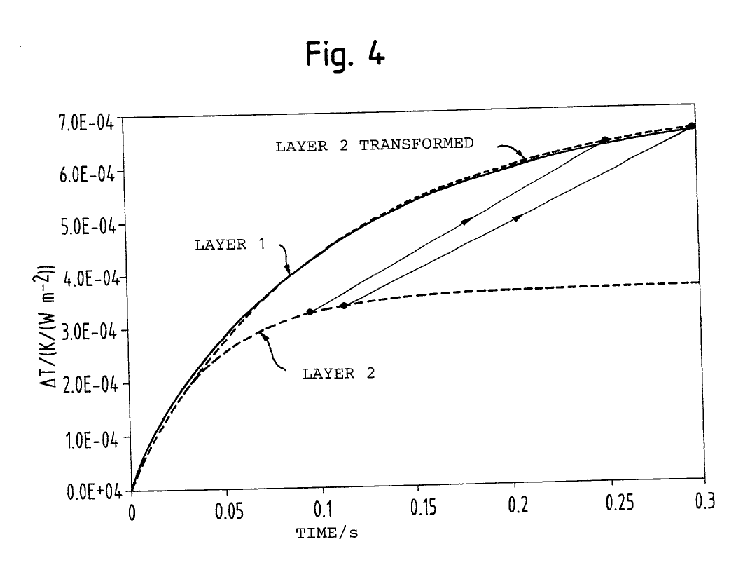

The task now is to determine the thickness of layer 2. The solution according to the invention is arrived at by finding an image which converts the temperature rise measured for layer 2 into the temperature rise of the calibration measurement of layer 1. The following approach is suggested to accomplish that: the temperature curve of layer 2 is mapped into the temperature curve of the calibration layer 1 by stretching it, both in time and amplitude. FIG. 4 illustrates this mapping. The stretching both in time and amplitude is selected so that the two curves will coincide as best as possible. That can be done, for instance, by the least squares method.

The invention provides a method of photothermal analysis of layers of material, especially of measuring the thickness of the layers, permitting calibration to be performed by a single measurement to which a reference layer is subjected. In FIG. 3, for example, that means to use one of the two temperature curves 1, 2 for calibration, while the other one is drawn upon to characterize the relevant layer of material. Let us assume in the instant example that the temperature curve or rise in temperature of layer 1 is selected as reference. Layer 2 in this case is the layer of material of which the thickness must be determined.

The invention is not limited to a certain way of determining the stretch factor. The stretch factor also may be determined along the lines of the standardization method specified in the same applicant's German patent application of the same filing date, entitled “Verfahren und Vorrichtung zur photothermischen Analyse einer Materialschicht, insbesondere zur Schichtdickenmessung” (“Method and apparatus for photothermal analysis of a layer of material, especially for thickness measurement thereof”) application no. 100 13 173.5. Reference is made to that patent application. The method specified in that patent application provides for standardizing the temperature curve of the heat radiation. A characteristic value then is derived from the standardized temperature curve to characterize the layer of material. According to a preferred embodiment, a first integral of the temperature curve of the heat radiation detected during a measuring interval and a second integral of the temperature curve during a standardization interval are calculated to achieve the standardization. The quotient between the first and second integrals serves as characteristic value to characterize the layer of material. A time-related stretch factor may be determined by identifying the points in time at which the characteristic values are the same for two different layers, such as layers 1 and 2 in FIG. 3.

The desired information about the thickness of layer 2 is contained in stretch factor Υ₂ in time, as results from the mapping because, in good approximation, the following relationship exists

$$\frac{L1}{L2} \approx \sqrt{{γ}_{2}} \qquad ( 3 )$$

where in L1 and L2 are the thicknesses of the layers.

The stretch factor for the above example results as Υ₂=2.648. Consequently a relationship of L1/L2=1.627 results from equation (3). This means that layer 2 is thinner by this factor than layer 1. Now, as the thickness of the calibration layer 1 is known, being 180 μm in the present example, the resulting thickness for layer 2 is 110.61 μm. In view of the fact that a value of 110 μm was used for calculating the temperature curves, this means a deviation of +0.5 per cent.

The statement made can be substantiated mathematically. First, an idealized system is taken as the starting point. It is assumed that complete absorption of the excitation takes place in the surface. That can be described by the following equation:

H(z)=I₀δ(z) (4)

Now, two-layer systems of the type shown in FIG. 2 are considered with z and z′

z′=γ₁z (5)

This means that the relationship between the thicknesses L1 and L2 of the layers corresponds to factor γ₁. Then the following applies:

∂z′²=γ₁²∂z² (6)

Inserting equations (4) and (6) in equation (2) provides:

$$\frac{{\partial }^{2} {T}^{′}}{\partial {z}^{′2}} ( {z}^{′} , t ) - \frac{1}{α} \cdot \frac{1}{{γ}_{1}^{2}} \frac{\partial {T}^{′}}{\partial t} ( {z}^{′} , t ) = \frac{- 1}{{γ}_{1}} \frac{{I}_{0}^{′} δ ( {z}^{′} )}{k} \qquad ( 7 )$$

If, on the other hand, one considers time-related stretching as:

$${t}^{′} = \frac{1}{{γ}_{2}} t \qquad ( 8 )$$

then the following applies:

$$\partial {t}^{′} = \frac{1}{{γ}_{2}} \partial t \qquad ( 9 )$$

Inserting equations (4) and (9) in equation (2) provides:

$$\frac{{\partial }^{2} {T}^{′}}{\partial {z}^{2}} ( z , {t}^{′} ) - \frac{1}{α} \cdot \frac{1}{{γ}_{2}} \frac{\partial {T}^{′}}{\partial {t}^{′}} ( z , {t}^{′} ) = - \frac{{I}_{0}^{′} δ ( z )}{k} \qquad ( 10 )$$

A comparison of equations (7) and (10) shows that, when including amplitude scaling, 1/Υ₁ solutions exist for which these two differential equations provided solutions. The two stretch factors Υ₁ and Υ₂, therefore, fulfill the following relationship:

γ₁²=γ₂ (11)

Based on this relationship (11), also the relationship between the thickness of the calibration layer 1 and that of layer 2 to be analyzed now is defined as follows:

$$\frac{{L}_{1}}{{L}_{2}} = \sqrt{{γ}_{2}} \qquad ( 12 )$$

Υ₂ is referred to as the time-related stretch factor.

Equation (7) further shows that the amplitude is scaled with 1/Υ₁ when stretched in space. Thus it would be conceivable also to utilize the amplitudes of the temperature curves for calibration and for determination of the layer thicknesses. Yet this will not be dealt with any further in the present context since the amplitude is rather sensitive to such things as measuring point distance, irradiation angle, etc.

With known stretching by factor Υ₂, the relationship between the thicknesses of layers 1 and 2 is defined precisely in accordance with equation (12). Strictly speaking, however, that is true only with idealized, total surface absorption. In reality, however, absorption in depth must be taken into consideration as well. That is demonstrated by equation (2) already with the excitation of H(z)=βI₀exp(-βz). If spatial stretching is undertaken with this excitation, the following differential equation will be obtained instead of equation (7):

$$\frac{{\partial }^{2} {T}^{′}}{\partial {z}^{′2}} ( {z}^{′} , t ) - \frac{1}{α} \cdot \frac{1}{{γ}_{1}^{2}} \frac{\partial {T}^{′}}{\partial t} ( {z}^{′} , t ) = - \frac{1}{{γ}_{1}^{2}} \frac{β {I}_{0}^{′} exp ( - \frac{β}{{γ}_{1}} {z}^{′} )}{k} \qquad ( 13 )$$

Equation (13) shows that in a model which is close to reality, not only is the excitation scaled but also the exponential drop in z-direction is influenced. Correctly speaking, therefore, equation (12) would read as already indicated in equation (3) above, namely

$$\frac{{L}_{1}}{{L}_{2}} \approx \sqrt{{γ}_{2}}$$

Studies have revealed that this method is only little sensitive to variations of the absorption coefficient á. For this reason the method starts from the assumption that absorption takes place near the surface. Moreover, a one-dimensional system is all that is considered here. Yet it was found that, in spite of all these simplifications, equation (3) is applicable in practice. Attention should be paid merely to not selecting a measuring range which would be too extreme. Simplifications gain in influence as the difference becomes greater between the thicknesses of the calibration layer 1 and the layer 2 to be determined, in other words the measuring error grows.

Starting from these considerations, the following method is proposed by the invention:

(1) A calibration measurement is made with the photothermal method, i.e. the temperature curve over time or temperature rise of layer 1 is measured and stored.

(2) Also the layer 2 to be determined is measured with the photothermal method, and this temperature curve likewise is stored.

(3) The rise in temperature of layer 2 as measured is stretched in time and amplitude so that either this temperature curve will coincide with the curve obtained from the calibration measurement (layer 1) or a minimum of deviation of the curves will result (e.g. by means of adequate compensation calculation), see also FIG. 4. This provides the time-related stretch factor Υ₂.

The above mentioned comparison of the temperature curves is a possible variant for determining the stretch factor. In principle, any method not dependent on amplitude and yielding an unambiguous characteristic value may be utilized for determining the stretch factors. In this case the characteristic values would be brought to coincide by stretching in time, and the time-related stretch factor Υ₂ thus be determined.

A statement, as to what the thicknesses of the layers are, can be made after these method steps already since the following relationship exists between the thicknesses, in accordance with equation (3):

$$\frac{{L}_{1}}{{L}_{2}} \approx \sqrt{{γ}_{2}} \qquad ( A )$$

In other words, where no absolute measurement of the thickness of a layer is required, these three initial steps already provide a measure of the percentage deviation of the thickness measured of layer 2 as against the thickness of layer 1 obtained by the calibration measurement. However, if it is desired that the absolute thickness of the layer be measured, the following additional steps should be taken:

(4) Annealing the reference layer.

(5) Measuring the resulting thickness of the layer by a conventional measuring technique (eddy current measurement).

(6) Memorizing the thickness of the reference layer (layer 1).

Having equation (3) and knowing the thickness of the reference layer 1, it is easy to infer the absolute thickness looked for of the measured layer 2.

As already mentioned, the method described is not suitable for use with measuring ranges of any desired width because of the simplifying assumptions made. Ultimately, what determines the measuring range is the measuring error which may be tolerable. If there is demand for a wide measuring range at small measuring error, improvement of the method can be obtained by the following embodiment:

Instead of one calibration measurement, several such measurements are made for different layer thicknesses so as to cover the desired measuring range. The temperature curve of the layer of interest is stored, as described above. This temperature curve is mapped into the temperature curves of the calibration measurements in the manner defined above. That will provide a time-related stretch factor for each curve of the calibration measurements. Thereupon the actual calibration measurement will be made using that calibration point at which the minimum time-related stretch factor was observed. It is likewise conceivable to carry out the calibration with two or more of these calibration points.

The invention may be applied in practice by means of an apparatus as illustrated in FIG. 1. The invention also may be realized by means of a computer program for evaluating the temperature curves detected by the detector 18. The evaluation unit 20 consequently may be implemented either by hardware or software or a combination thereof. The computer program may be memorized on a data carrier, and it may execute the method steps claimed in electronic data processing equipment.

The features disclosed in the specification above, in the claims and drawings may be essential to the invention in its various embodiments, both individually and in any combination.

What is claimed is:

1. A method of photothermal analysis of a layer of material (16), especially of measuring the thickness of a layer, wherein the surface of a first layer of material (16) is excited by electromagnetic radiation (S) and heat radiation (T) emitted by said surface and having a first temperature response curve is detected, and the surface of a second layer of material (16) is excited and heat radiation (T) emitted by said surface and having a second temperature response curve is detected, wherein a stretch factor is determined between the first and second temperature response curves, and the stretch factor is used as a characteristic value for a ratio between said first and second layers of material (16).

2. The method as claimed in claim 1, wherein the first layer of material used is a reference layer and the second layer of material is the layer of material (16) to be analyzed.

3. The method as claimed in claim 1, wherein the stretch factor is a time-related stretch factor Υ₂.

4. The method as claimed in claim 3, wherein the ratio of the layer thicknesses is derived in dependence on the stretch factor.

5. The method as claimed in claim 4, wherein the thickness of the second layer of material is determined in dependence on the thickness of the first layer of material according to the following equation:
$$\frac{{L}_{1}}{{L}_{2}} \approx \sqrt{{γ}_{2}}$$
wherein
L1=thickness of the first layer of material,
L2=thickness of the second layer of material, and
Υ₂=time-related stretch factor.

6. The method as claimed in claim 1 or 2, wherein the stretch factor Υ₁ is related to the amplitudes of the temperature response curves.

7. The method as claimed in claim 6, wherein the thickness of the second layer of material is determined according to the following equation:
$$\frac{L1}{L2} \approx {γ}_{1}$$
wherein
L1=thickness of the first layer of material,
L2=thickness of the second layer of material, and
Υ₁=amplitude stretch factor.

8. The method as claimed in claim 1, wherein the second temperature response curve is mapped into the first temperature response curve for determining the stretch factor.

9. The method as claimed in claim 1, wherein an amplitude-independent characteristic value is determined for each temperature response curve, the stretch factor being determined in dependence on said characteristic values.

10. The method as claimed in claim 9, wherein the time-related stretch factor is determined on the basis of the time intervals during which the characteristic values are identical.

11. The method as claimed in claim 1, wherein at least the first temperature response curve is stored.

12. The method as claimed in claim 11, wherein the absolute thickness of the reference layer is determined, and the absolute thickness of the layer of material (16) to be analyzed is determined in dependence on the same.

13. The method as claimed in claim 1, wherein the surfaces each are excited with a step function of the electromagnetic radiation (S).

14. An apparatus for photothermal analysis of a layer of material, especially for measuring the thickness of a layer, comprising
a excitation source (10) for exciting the surfaces of at least first and second layers of material (16);
a detector (18) for detecting the heat radiation (T) emitted by the surfaces of the layers and having first and second temperature response curves, respectively; and
an evaluation unit (20),wherein the evaluation unit (20) determines a stretch factor between the first temperature response curve and the second temperature response curve, the stretch factor being used as a characteristic value of a ratio between the first and second layers of material (16).

15. A computer program for photothermal analysis of a layer of material (16), especially for measuring the thickness of a layer, wherein the surface of a first layer of material is excited by electromagnetic radiation and heat radiation emitted by said surface and having a first temperature response curve is detected, and the surface of a second layer of material is excited and heat radiation emitted by said surface and having a second temperature response curve is detected, wherein the computer program executes the following steps:
calculating a stretch factor between the first temperature response curve and the second temperature response curve and
using the stretch factor as a characteristic value of a ratio between the first and second layers of material.
